(19) United States
(12) Patent Application Publication
(10) Pub. No.: US 2025/0145153 A1
(43) Pub. Date: May 8, 2025

(54) VEHICLE CONTROL APPARATUS

(71) Applicant: TOYOTA JIDOSHA KABUSHIKI KAISHA, Toyota-shi (JP)

(72) Inventors: Sei MIYAZAKI, Susono-shi (JP); Kenichi SHIMIZU, Gotemba-shi (JP)

(73) Assignee: TOYOTA JIDOSHA KABUSHIKI KAISHA, Toyota-shi (JP)

(21) Appl. No.: 18/909,949

(22) Filed: Oct. 9, 2024

(30) Foreign Application Priority Data
Nov. 8, 2023 (JP) 2023-190830

(51) Int. Cl. B60W 30/09; B60W 30/095; B60W 50/02

(52) U.S. Cl. CPC B60W 30/09; B60W 30/0953; B60W 30/0956; B60W 50/0205; B60W 2540/221

(57) ABSTRACT

A vehicle control apparatus executes vehicle control for reducing a collision risk of colliding with a vehicle when an object having the collision risk is present. The vehicle control apparatus is configured to: prohibit execution of the vehicle control when an operation relating to a behavior of the vehicle by a driver satisfies a predetermined prohibition condition; permit execution of the vehicle control even when the prohibition condition is met when an acceleration operation for accelerating the vehicle satisfies a predetermined permission condition; and cause the permission condition to be met more easily when at least one of a state of the driver or a traveling state of the vehicle is an abnormal state as compared to when both of the state of the driver and the traveling state of the vehicle are a normal state.

### CROSS-REFERENCE TO RELATED APPLICATION

This application claims priority to Japanese Patent Application No. 2023-190830 filed on Nov. 8, 2023, incorporated herein by reference in its entirety.

### BACKGROUND

### 1. Technical Field

The present disclosure relates to a vehicle control apparatus that executes vehicle control for reducing a collision risk of colliding with a vehicle when an object having the collision risk is present.

### 2. Description of Related Art

A vehicle control apparatus that executes vehicle control for reducing a collision risk has hitherto been known. For example, a vehicle control apparatus (hereinafter referred to as a “related-art apparatus”) described in Japanese Unexamined Patent Application Publication No. 2022-108822 determines whether a duration time of a state in which the vehicle speed is equal to or more than a predetermined speed is equal to or more than a predetermined amount of time when an accelerator operation amount is equal to or more than a predetermined operation amount during the execution of vehicle control. When the duration time is less than the predetermined amount of time, the related-art apparatus determines that a driver intends to accelerate and prohibits the execution of the vehicle control. Meanwhile, when the duration time is equal to or more than the predetermined amount of time, the related-art apparatus determines that the driver does not intend to accelerate and permits the execution of the vehicle control.

### SUMMARY

When at least one of the state of a driver and the traveling state of a vehicle is an abnormal state, there is a possibility that the driver is continuing acceleration operation although the driver does not intend to accelerate. In such a case, vehicle control needs to be permitted as speedily as possible. However, the related-art apparatus cannot permit the vehicle control until the duration time becomes equal to or more than the predetermined amount of time once the vehicle control is prohibited.

The present disclosure has been made to address the problem described above. In other words, an object of the present disclosure is to provide a vehicle control apparatus capable of reducing a collision risk by causing vehicle control to be more easily permitted when at least one of a state of a driver and a traveling state of a vehicle is an abnormal state.

A vehicle control apparatus of the present disclosure (hereinafter also referred to as a “present disclosure apparatus”) executes vehicle control for reducing a collision risk of colliding with a vehicle (Step 335) when an object having the collision risk is present (Step 320 “Yes”).
The vehicle control apparatus is configured to:
   prohibit execution of the vehicle control (Step 415, Step 420, Step 325) when an operation relating to a behavior of the vehicle by a driver satisfies a predetermined prohibition condition (Step 410 “Yes”);
   permit execution of the vehicle control (Step 460) even when the prohibition condition is met when an acceleration operation for accelerating the vehicle satisfies a predetermined permission condition (Step 430 “Yes”, Step 435, Step 455 “Yes”); and
   cause the permission condition to be met more easily (Step 465, Step 470) when a facilitation condition in which at least one of a state of the driver or a traveling state of the vehicle is an abnormal state is met (Step 445 “Yes”, Step 450 “Yes”) as compared to when the facilitation condition is not met (Step 445 “No”, Step 450 “No”).

When the facilitation condition in which at least one of the state of the driver or the traveling state of the vehicle is an abnormal state is met, the permission condition is met more easily as compared to when the facilitation condition is not met. As a result, when at least one of the state of the driver or the traveling state of the vehicle is an abnormal state, the permission condition is met more easily, and the possibility of being able to promptly execute the vehicle control increases. Therefore, it becomes possible to reduce the collision risk.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a system configuration of a vehicle control apparatus according to an embodiment of the present disclosure;

FIG. 2 is an explanatory diagram of an operation example of the vehicle control apparatus according to the embodiment of the present disclosure;

FIG. 3 is a flowchart showing a vehicle control routine executed by a CPU of an ECU shown in FIG. 1;

FIG. 4 is a flowchart showing a prohibition determination routine executed by the CPU of the ECU shown in FIG. 1; and

FIG. 5 is a flowchart showing an abnormal state determination routine executed by the CPU of the ECU shown in FIG. 1.

### DETAILED DESCRIPTION OF EMBODIMENTS

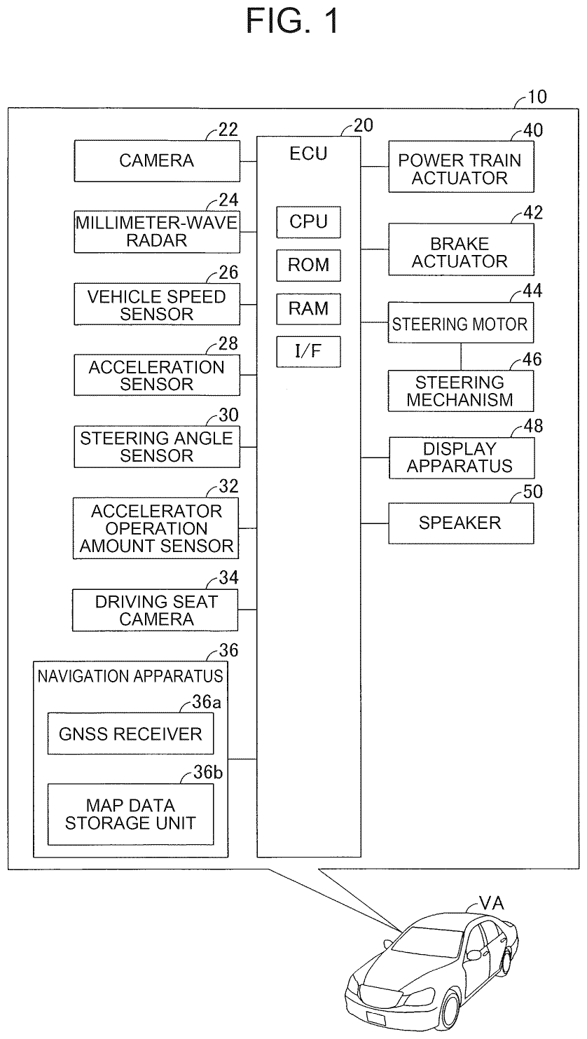

As shown in FIG. 1, a vehicle control apparatus according to the present embodiment (hereinafter referred to as a “present apparatus 10”) is applied to a vehicle VA and includes components shown in FIG. 1.

The ECU 20 executes vehicle control for reducing a collision risk of colliding with a vehicle VA when an object having the collision risk is present. As one example, the vehicle control is deceleration control that decelerates a vehicle VA. The vehicle control may be alarm control for informing the driver that a collision risk is present or may be turning control of autonomously turning the vehicle VA to avoid the object having a collision risk.

In the present specification, the “ECU” is an electronic control apparatus including a microcomputer as a main part. The ECU is also referred to as a controller or a computer. The microcomputer includes a CPU (processor), a ROM, a RAM, an interface (I/F), and the like. The CPU realizes various functions by executing an instruction (routine) stored in a memory (ROM). At least one function realized by the ECU 20 may be realized by a plurality of ECUs.

A camera 22 acquires image data by photographing scenery ahead of the vehicle VA. The camera 22 acquires camera object information and border information on the basis of the image data. The camera object information includes a position of an object positioned ahead of the vehicle VA with respect to the vehicle VA. The border information includes positions of borders BL that define a traveling lane TA with respect to the vehicle VA. Examples of the borders BL are walls, curbs, guardrails, and white lines on a road. The camera 22 transmits the image data, the camera object information, and the border information to the ECU 20.

A millimeter-wave radar 24 acquires radar object information including “the position of the object with respect to the vehicle VA” and “a relative speed Vr of the object with respect to the vehicle VA” by transmitting millimeter waves to a place ahead of the vehicle VA and receiving reflected waves obtained by reflection of the transmitted millimeter waves by the object. The millimeter-wave radar 24 transmits the radar object information to the ECU 20.

A vehicle speed sensor 26 detects a vehicle speed Vs indicating the speed of the vehicle VA. An acceleration sensor 28 detects an acceleration G in the front-rear axial direction of the vehicle VA. In the present embodiment, the acceleration G becomes a positive value when the vehicle VA is accelerated and becomes a negative value when the vehicle VA is decelerated. A steering angle sensor 30 detects a steering angle θ of a steering wheel (not shown). The accelerator operation amount sensor 32 detects an operation amount AP of an accelerator pedal (not shown). The operation of the accelerator pedal may be referred to as “acceleration operation”. The acceleration operation is one type of operation relating to the behavior of the vehicle VA performed by the driver. The ECU 20 acquires detection values of those sensors 26 to 32.

A driving seat camera 34 acquires driving seat image data by photographing a region including a face of the driver sitting on a driving seat of the vehicle VA. The driving seat camera 34 transmits the driving seat image data to the ECU 20.

A navigation apparatus 36 has a global navigation satellite system (GNSS) receiver 36a and a map data storage unit 36b. The GNSS receiver 36a receives signals from a plurality of artificial satellites and specifies a current position (a latitude and a longitude) of the vehicle VA based on the received signals. The map data storage unit 36b stores therein map data. The map data is data relating to a movement permission direction of a lane on a road and a speed limit Vsth of the lane.

A power train actuator 40 changes a driving force generated by a driving apparatus (for example, an internal combustion engine and/or an electric motor) of the vehicle VA. The brake actuator 42 controls a braking force applied to wheels of the vehicle VA. A steering motor 44 is integrated in a steering mechanism 46. The steering mechanism 46 is a mechanism for turning a turning wheel in accordance with the operation of the steering wheel. The steering motor 44 generates an assist torque for assisting the operation of the steering wheel in the steering mechanism 46 and generates an autonomous steering torque for changing a turning angle of the turning wheel in the steering mechanism 46 in accordance with commands from the ECU 20.

A display apparatus 48 displays an alarm screen for informing the driver that a collision risk is present by alarm control. The speaker 50 issues a buzzer sound for informing the driver that a collision risk is present by the alarm control.

### Overview of Operation

When an operation relating to the behavior of the vehicle VA by the driver satisfies a predetermined prohibition condition, the ECU 20 prohibits the execution of the vehicle control and controls the vehicle VA in accordance with the operation. As one example, the prohibition condition is met when the operation amount AP is equal to or more than a first threshold operation amount APth1. The ECU 20 ends the vehicle control when the prohibition condition is met during the execution of the vehicle control. When the prohibition condition is met before the execution of the vehicle control, the ECU 20 does not execute the vehicle control even when the object having a collision risk is present.

When a permission condition in which an duration time T in which the operation amount AP is equal to or more than the first threshold operation amount APth1 is equal to or more than a threshold amount of time Tth is met, the ECU 20 permits the execution of the vehicle control.

When a facilitation condition in which at least one of the state of the driver and the traveling state of the vehicle VA is an abnormal state is met, the ECU 20 causes the permission condition to be met more easily as compared to a case in which the facilitation condition is not met (in other words, a case in which both the state of the driver and the traveling state of the vehicle VA are a normal state). The ECU 20 determines that the state of the driver is an abnormal state when the driver is dozing off, has fainted, or is having a convulsion on the basis of the driving seat image data. When the vehicle VA goes over the border BL (when the vehicle VA travels outside the traveling lane TA), when the vehicle VA is traveling in the wrong direction, or when the vehicle speed Vs is equal to or more than the speed limit, the ECU 20 determines that the traveling state of the vehicle VA is an abnormal state.

In the present embodiment, the ECU 20 causes the permission condition to be met more easily by causing the threshold amount of time Tth used when the facilitation condition is met to be shorter than the threshold amount of time Tth used when the facilitation condition is not met.

As a result, the vehicle control is more easily performed when at least one of the state of the driver and the traveling state of the vehicle VA is an abnormal state, and the collision risk can be reduced.

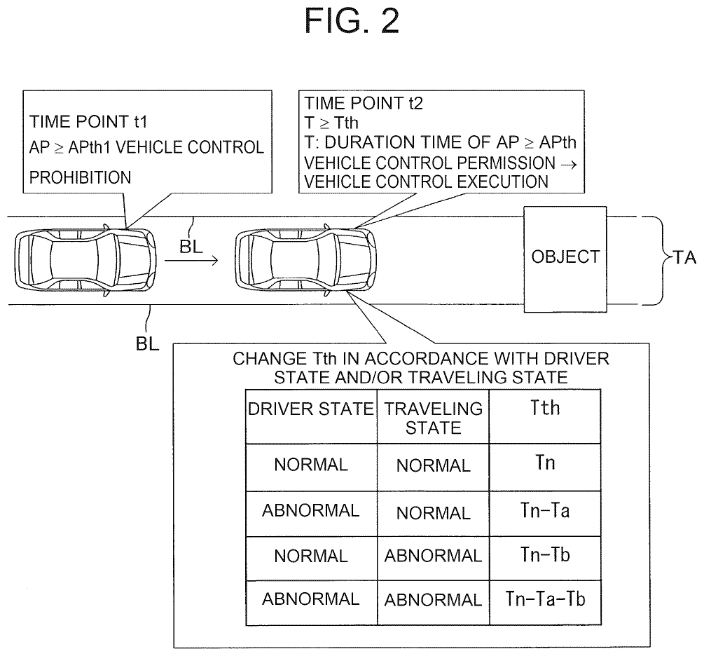

As shown in FIG. 2, when the state of the driver is a normal state and the traveling state of the vehicle VA is a normal state, the threshold amount of time Tth is set to a normal amount of time Tn. When the state of the driver is an abnormal state and the traveling state of the vehicle VA is a normal state, the threshold amount of time Tth is set to an amount of time (Tn−Ta) obtained by subtracting a first amount of time Ta from the normal amount of time Tn. When the state of the driver is a normal state and the traveling state of the vehicle VA is an abnormal state, the threshold amount of time Tth is set to an amount of time (Tn−Tb) obtained by subtracting a second amount of time Tb from the normal amount of time Tn.

When the state of the driver is an abnormal state and the traveling state of the vehicle VA is an abnormal state, the threshold amount of time Tth is set to an amount of time (Tn−Ta−Tb) obtained by subtracting the first amount of time Ta and the second amount of time Tb from the normal amount of time Tn. In other words, when both of the state of the driver and the traveling state of the vehicle VA are an abnormal state, the threshold amount of time Tth becomes smaller (the permission condition is met more easily) as compared to a case in which either the state of the driver or the traveling state of the vehicle VA is an abnormal state. When both of the state of the driver and the traveling state of the vehicle VA are an abnormal state, the urgency degree is higher as compared to when either the state of the driver or the traveling state of the vehicle VA is an abnormal state. Therefore, the permission condition is caused to be met more easily, and hence the vehicle control is executed more easily.

### Operation Example

An operation example of the present apparatus 10 is described with reference to FIG. 2.

The ECU 20 executes the vehicle control at a time point before a time point t1. At the time point t1, the operation amount AP becomes equal to or more than the first threshold operation amount APth1 and the prohibition condition is met, and hence the ECU 20 ends the vehicle control that is executed.

At a time point t2, the duration time T in which the operation amount AP is equal to or more than the first threshold operation amount APth1 becomes equal to or more than the threshold amount of time Tth, and the ECU 20 permits the execution of the vehicle control. In this case, an object having a collision risk is present, and hence the ECU 20 executes the vehicle control.

The ECU 20 determines that the state of the driver is an abnormal state and the traveling state of the vehicle VA is a normal state and sets the threshold amount of time Tth to the amount of time (Tn−Ta).

### Specific Operation

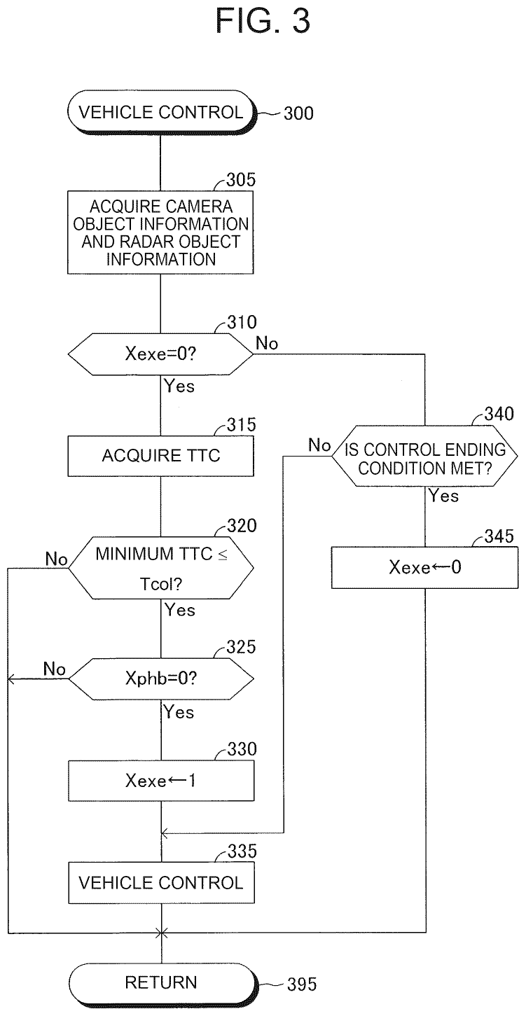

The CPU of the ECU 20 executes routines shown in FIG. 3 to FIG. 5 by flowcharts each time a predetermined amount of time elapses.

### Vehicle Control Routine

When a suitable time point arrives, the CPU starts processing from Step 300 in FIG. 3 and executes Step 305 and Step 310.

Step 305: The CPU acquires camera object information and radar object information and specifies the position of the object on the basis of the camera object information and the radar object information.

Step 310: The CPU determines whether the value of an execution flag Xexe is “0”.

The value of the execution flag Xexe is set to “1” when the vehicle control is started and is set to “0” when the vehicle control is ended. The value of the execution flag Xexe is set to “0” by an initialization routine. The initialization routine is executed by the CPU when an ignition key switch (not shown) of the vehicle VA is changed from an OFF position to an ON position.

When the value of the execution flag Xexe is “0”, the CPU makes a determination of “Yes” in Step 310 and executes Step 315 and Step 320.

Step 315: The CPU acquires a time to collision (TTC) of each object on the basis of the camera object information and the radar object information. The TTC indicates an amount of time it takes until the vehicle VA collides with the object. In detail, the CPU acquires the TTC by dividing a distance D between the vehicle VA and the object by the relative speed Vr. The collision risk increases as the TTC becomes smaller.

Step 320: The CPU determines whether a minimum TTC is equal to or less than a predetermined collision amount of time Tcon.

When the minimum TTC is greater than the collision amount of time Tcon, the CPU determines that an object having a collision risk is not present and makes a determination of “No” in Step 320. Then, the processing proceeds to Step 395, and the CPU temporarily ends the present routine.

When the minimum TTC is equal to or less than the collision amount of time Tcon, the CPU determines that an object having a collision risk is present and makes a determination of “Yes” in Step 320. Then, the processing proceeds to Step 325, and the CPU determines whether the value of a prohibition flag Xphb is “0”.

The value of the prohibition flag Xphb is set to “0” when the execution of the vehicle control is permitted and is set to “1” when the execution of the vehicle control prohibited. The value of the prohibition flag Xphb is set to “0” by the initialization routine.

When the value of the prohibition flag Xphb is “0”, the CPU makes a determination of “Yes” in Step 325 and executes Step 330 and Step 335.

Step 330: The CPU sets the value of the execution flag Xexe to “1”.

Step 335: The CPU executes the vehicle control.

In the vehicle control, the CPU controls the power train actuator 40 and the brake actuator 42 such that the acceleration G coincides with a predetermined negative acceleration Gpd.

Then, the processing proceeds to Step 395, and the CPU temporarily ends the present routine.

When the value of the prohibition flag Xphb is “1”, the CPU makes a determination of “No” in Step 325. Then, the processing proceeds to Step 395, and the CPU temporarily ends the present routine. Therefore, when the value of the prohibition flag Xphb is “1”, the vehicle control is not executed even when an object having a collision risk is present.

Meanwhile, when the value of the execution flag Xexe is “1” when the processing proceeds to Step 310, the CPU makes a determination of “No” in Step 310, and the processing proceeds to Step 340. In Step 340, the CPU determines whether a control ending condition is met. In detail, the CPU determines that the control ending condition is met when either Condition E1 or Condition E2 below is met.

Condition E1: A predetermined amount of time has elapsed from when the vehicle VA is stopped.

Condition E2: The collision risk with an object is removed.

When the control ending condition is not met, the CPU makes a determination of “No” in Step 340, and the processing proceeds to Step 335. When the control ending condition is met, the CPU makes a determination of “Yes” in Step 340, and the processing proceeds to Step 345. In Step 345, the CPU sets the value of the execution flag Xexe to “0”. Then, the processing proceeds to Step 395, and the CPU temporarily ends the present routine.

### Prohibition Determination Routine

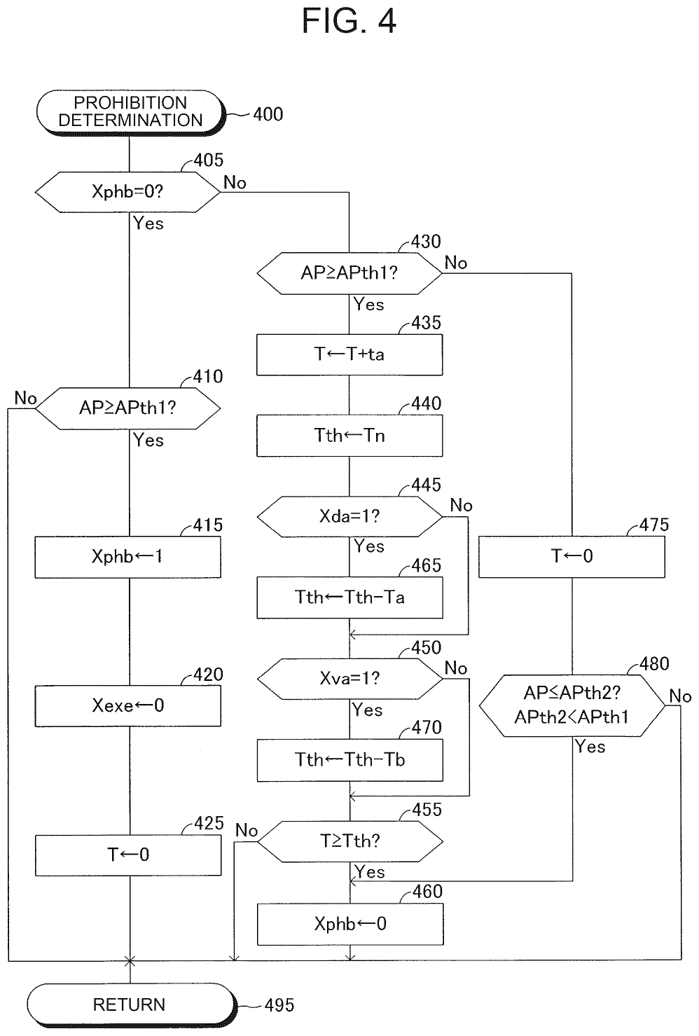

When a suitable time point arrives, the CPU starts processing from Step 400 in FIG. 4, and the processing proceeds to Step 405. In Step 405, the CPU determines whether the value of the prohibition flag Xphb is “0”.

When the value of the prohibition flag Xphb is “0”, the CPU makes a determination of “Yes” in Step 405, and the processing proceeds to Step 410. In Step 410, the CPU determines whether the operation amount AP is equal to or more than the first threshold operation amount APth1.

When the operation amount AP is less than the first threshold operation amount APth1, the CPU determines that the prohibition condition is not met. In this case, the CPU makes a determination of “No” in Step 410, the processing proceeds to Step 495, and the CPU temporarily ends the present routine. When the operation amount AP is equal to or more than the first threshold operation amount APth1, the CPU determines that the prohibition condition is met. In this case, the CPU makes a determination of “Yes” in Step 410 and executes Step 415 to Step 425.

Step 415: The CPU sets the value of the prohibition flag Xphb to “1”.

Step 420: The CPU sets the value of the execution flag Xexe to “0”.

Step 425: The CPU sets the value of a timer T to “0”. The timer T is a timer for counting the duration time T in which the operation amount AP is equal to or more than the first threshold operation amount APth1.

Then, the processing proceeds to Step 495, and the CPU temporarily ends the present routine.

When the value of the prohibition flag Xphb is “1” when the processing proceeds to Step 405, the CPU makes a determination of “No” in Step 405, and the processing proceeds to Step 430. In Step 430, the CPU determines whether the operation amount AP is equal to or more than the first threshold operation amount APth1.

When the operation amount AP is equal to or more than the first threshold operation amount APth1, the CPU makes a determination of “Yes” in Step 430 and executes Step 435 to Step 445.

Step 435: The CPU adds “a predetermined amount of time ta that is an execution interval of the present routine” to the timer T.

Step 440: The CPU sets the threshold amount of time Tth to the normal amount of time Tn.

Step 445: The CPU determines whether the value of a driver state flag Xda is “1”.

The value of the driver state flag Xda is set to “1” when the state of the driver is an abnormal state and is set to “0” when the state of the driver is a normal state. The value of the driver state flag Xda is set to “0” by the initialization routine.

When the value of the driver state flag Xda is “0”, the CPU makes a determination of “No” in Step 445, and the processing proceeds to Step 450. In Step 450, the CPU determines whether the value of a traveling state flag Xva is “1”.

The value of the traveling state flag Xva is set to “1” when the traveling state of the vehicle VA is an abnormal state and is set to “0” when the traveling state of the vehicle VA is a normal state. The value of the traveling state flag Xva is set to “0” by the initialization routine.

When the value of the traveling state flag Xva is “0”, the CPU makes a determination of “No” in Step 450, and the processing proceeds to Step 455. In Step 455, the CPU determines whether the timer T is equal to or more than the threshold amount of time Tth.

When the timer T is less than the threshold amount of time Tth, the CPU makes a determination of “No” in Step 455, the processing proceeds to Step 495, and the CPU temporarily ends the present routine. Meanwhile, when the timer T is equal to or more than the threshold amount of time Tth, the CPU makes a determination of “Yes” in Step 455, and the processing proceeds to Step 460. In Step 460, the CPU sets the value of the prohibition flag Xphb to “0”. In other words, the CPU permits the execution of the vehicle control. Then, the processing proceeds to Step 495, and the CPU temporarily ends the present routine.

When the value of the driver state flag Xda is “1” when the processing proceeds to Step 445, the CPU makes a determination of “Yes” in Step 445, and the processing proceeds to Step 465. In Step 465, the CPU sets the threshold amount of time Tth to “a value (Tn−Ta) obtained by subtracting the first amount of time Ta from the threshold amount of time Tth set to the normal amount of time Tn in Step 440”. Then, the processing proceeds to Step 450.

When the value of the traveling state flag Xva is “1” when the processing proceeds to Step 450, the CPU makes a determination of “Yes” in Step 450, and the processing proceeds to Step 470. In Step 470, the CPU sets the threshold amount of time Tth to “a value obtained by subtracting the second amount of time Tb from the current threshold amount of time Tth”. Then, the processing proceeds to Step 455. The current threshold amount of time Tth is set to the normal amount of time Tn when the value of the driver state flag Xda is “0”, and the current threshold amount of time Tth is set to the value (Tn−Ta) when the value of the driver state flag is “1”.

When the operation amount AP is less than the first threshold operation amount APth1 when the processing proceeds to Step 430, the CPU makes a determination of “No” in Step 430 and executes Step 475 and Step 480.

Step 475: The CPU sets the timer T to “0”.

Step 480: The CPU determines whether the operation amount AP is equal to or less than a second threshold operation amount APth2 set to a value smaller than the first threshold operation amount APth1.

When the operation amount AP is greater than the second threshold operation amount APth2, the CPU makes a determination of “No” in Step 480, the processing proceeds to Step 495, and the CPU temporarily ends the present routine. When the operation amount AP is equal to or less than the second threshold operation amount APth2, the CPU makes a determination of “Yes” in Step 480, the processing proceeds to Step 460, and the CPU sets the value of the prohibition flag Xphb to “0”.

### Abnormal State Determination Routine

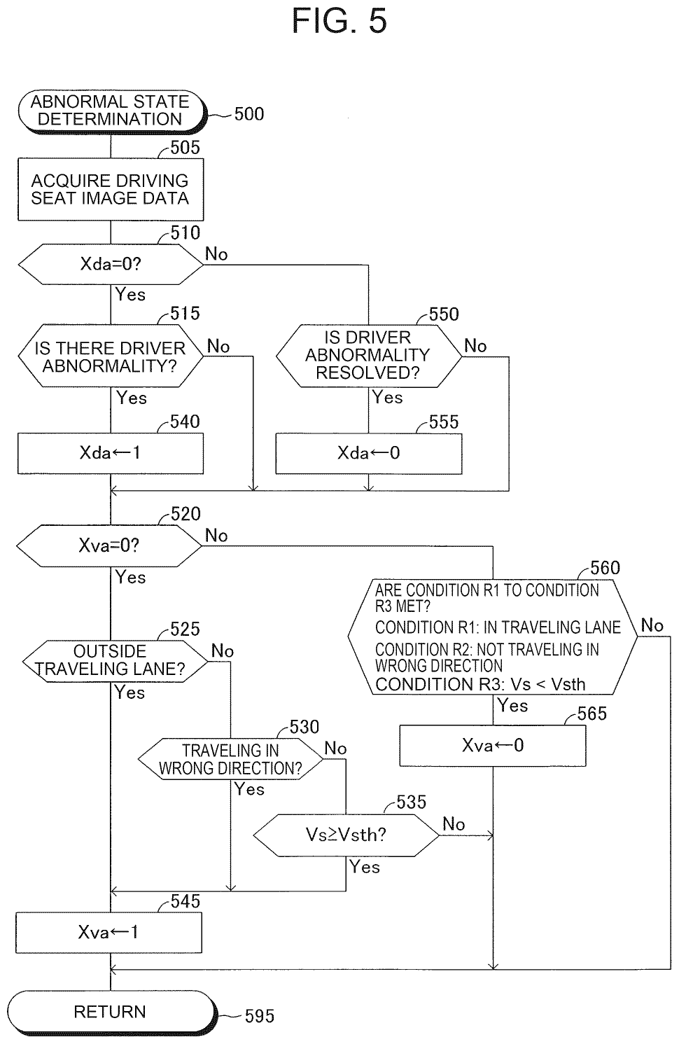

When a suitable time point arrives, the CPU starts processing from Step 500 in FIG. 5 and executes Step 505 and Step 510.

Step 505: The CPU acquires driving seat image data.

Step 510: The CPU determines whether the value of the driver state flag Xda is “0”.

When the value of the driver state flag Xda is “0”, the CPU makes a determination of “Yes” in Step 510, and the processing proceeds to Step 515. In Step 515, the CPU determines whether the state of the driver is an abnormal state on the basis of the driving seat image data.

When the state of the driver is a normal state, the CPU makes a determination of “No” in Step 515, and the processing proceeds to Step 520. In Step 520, the CPU determines whether the value of the traveling state flag Xva is “0”.

When the value of the traveling state flag Xva is “0”, the CPU makes a determination of “Yes” in Step 520, and the processing proceeds to Step 525. In Step 525, the CPU determines whether the vehicle VA is traveling outside the traveling lane TA on the basis of the border information acquired from the camera 22. In detail, the CPU determines that the vehicle VA is traveling outside the traveling lane TA when the vehicle VA goes over the border BL.

When the vehicle VA is traveling in the traveling lane TA, the CPU makes a determination of “No” in Step 525, and the processing proceeds to Step 530. In Step 530, the CPU determines whether the vehicle VA is traveling in the wrong direction. In detail, the CPU acquires “a movement permission direction in which movement is permitted in the traveling lane in which the vehicle VA is traveling” with reference to the map data stored in the map data storage unit 36b and determines that the vehicle VA is traveling in the wrong direction when the movement direction of the vehicle VA is not the movement permission direction.

When the vehicle VA is not traveling in the wrong direction, the CPU makes a determination of “No” in Step 530, and the processing proceeds to Step 535. In Step 535, the CPU determines whether the vehicle speed Vs is equal to or more than the speed limit Vsth. In detail, the CPU acquires the speed limit Vsth in the current position of the vehicle VA in the lane in which the vehicle VA is traveling on the basis of the map data stored in the map data storage unit 36b and determines whether the vehicle speed Vs is equal to or more than the speed limit Vsth.

When the vehicle speed Vs is less than the speed limit Vsth, the CPU makes a determination of “No” in Step 535, the processing proceeds to Step 595, and the CPU temporarily ends the present routine.

When the state of the driver is an abnormal state when the processing proceeds to Step 515, the CPU makes a determination of “Yes” in Step 515, and the processing proceeds to Step 540. In Step 540, the CPU sets the value of the driver state flag Xda to “1”. Then, the processing proceeds to Step 520.

When the vehicle VA is traveling outside the traveling lane TA when the processing proceeds to Step 525, the CPU makes a determination of “Yes” in Step 525, and the processing proceeds to Step 545. In Step 545, the CPU sets the value of the traveling state flag Xva to “1”. Then, the processing proceeds to Step 595, and the CPU temporarily ends the present routine.

When the vehicle VA is traveling in the wrong direction when the processing proceeds to Step 530, the CPU makes a determination of “Yes” in Step 530, and the processing proceeds to Step 545. When the vehicle speed Vs is equal to or more than the speed limit Vsth when the processing proceeds to Step 535, the CPU makes a determination of “Yes” in Step 535, and the processing proceeds to Step 545.

When the value of the driver state flag Xda is “1” when the processing proceeds to Step 510, the CPU makes a determination of “No” in Step 510, and the processing proceeds to Step 550. In Step 550, the CPU determines whether the abnormal state of the driver is resolved and the state of the driver has become a normal state on the basis of the driving seat image data.

When the state of the driver is an abnormal state, the CPU makes a determination of “No” in Step 550, and the processing proceeds to Step 520. Meanwhile, when the state of the driver becomes a normal state, the CPU makes a determination of “Yes” in Step 550, and the processing proceeds to Step 555. In Step 555, the CPU sets the value of the driver state flag Xda to “0”, and the processing proceeds to Step 520.

When the value of the traveling state flag Xva is “1” when the processing proceeds to Step 520, the CPU makes a determination of “No” in Step 520, and the processing proceeds to Step 560. In Step 560, the CPU determines whether all of Condition R1 to Condition R3 below are met.
Condition R1: The vehicle VA is traveling in the traveling lane TA.
Condition R2: The vehicle VA is not traveling in the wrong direction.
Condition R3: The vehicle speed Vs is less than the speed limit Vsth.

When at least one of Condition R1 to Condition R3 is not met, the CPU determines that the traveling state of the vehicle VA is still an abnormal state. In this case, the CPU makes a determination of “No” in Step 560, the processing proceeds to Step 595, and the CPU temporarily ends the present routine. Meanwhile, when all of Condition R1 to Condition R3 are met, the CPU determines that the traveling state of the vehicle VA has become a normal state, and the processing proceeds to Step 565. In Step 565, the CPU sets the value of the traveling state flag Xva to “0”. Then, the processing proceeds to Step 595 and temporarily ends the present routine.

According to the present embodiment, the threshold amount of time Tth when the facilitation condition in which at least one of the state of the driver and the traveling state of the vehicle VA is an abnormal state is met (Step 465, Step 470) is smaller than the threshold amount of time Tth (Step 440) when the facilitation condition is not met. As a result, the amount of time it takes until the execution of the vehicle control is permitted can be caused to be as short as possible when at least one of the state of the driver and the traveling state of the vehicle VA is an abnormal state.

### First Modified Example

In the embodiment, it is determined that the prohibition condition is met when the operation amount AP is equal to or more than the first threshold operation amount APth1 (see Step 410 shown in FIG. 4), and it is determined that the permission condition is met when the duration time T in which the operation amount AP is equal to or more than the first threshold operation amount APth1 (see Step 430) is equal to or more than the threshold amount of time Tth. “The first threshold operation amount APth1 used in the prohibition condition (Step 410)” and “the first threshold operation amount APth1 used in the permission condition (Step 430)” may be different values. In this case, the threshold operation amount (prohibition threshold operation amount) used in the prohibition condition is set to a value smaller than the threshold operation amount (permission threshold operation amount) used in the permission condition. In the embodiment, the permission threshold operation amount and the prohibition threshold operation amount are set to a same value. However, in the present modified example, the prohibition threshold operation amount is set to a value smaller than the permission threshold operation amount, and hence the prohibition threshold operation amount only needs to be set to a value equal to or less than the permission threshold operation amount.

### Second Modified Example

In the embodiment, the permission condition may be caused to be met more easily by causing the first threshold operation amount APth1 used in the permission condition to be smaller when the facilitation condition is met as compared to when the facilitation condition is not met.

### Third Modified Example

The prohibition condition may be met when the operation amount of a brake pedal becomes equal to or more than a threshold operation amount or may be met when a steering angle θ becomes equal to or more than a threshold angle θth instead of the operation amount AP.

### Fourth Modified Example

In the embodiment, it is determined that the object having a collision risk is present and the vehicle control is executed when the TTC is equal to or less than the collision amount of time Tcon. However, the present disclosure is not limited thereto. For example, it may be determined that an object having a collision risk is present and the vehicle control may be executed when the distance between the vehicle VA and the object is equal to or less than a threshold distance.

### Fifth Modified Example

The prohibition determination routine may be executed when the vehicle control is executed (in other words, the value of the execution flag Xexe is “1”).

The present apparatus 10 is applicable to vehicles such as an engine automobile, a hybrid electric vehicle, a plug-in hybrid electric vehicle, a fuel cell electric vehicle, and a battery electric vehicle. The present apparatus 10 is also applicable to an autonomous driving vehicle.

What is claimed is:

1. A vehicle control apparatus that executes vehicle control for reducing a collision risk of colliding with a vehicle when an object having the collision risk is present, wherein:
the vehicle control apparatus is configured to:
prohibit execution of the vehicle control when an operation relating to a behavior of the vehicle by a driver satisfies a predetermined prohibition condition;
permit execution of the vehicle control even when the prohibition condition is met when an acceleration operation for accelerating the vehicle satisfies a predetermined permission condition; and
cause the permission condition to be met more easily when a facilitation condition in which at least one of a state of the driver or a traveling state of the vehicle is an abnormal state is met as compared to when the facilitation condition is not met.

2. The vehicle control apparatus according to claim 1, wherein the vehicle control apparatus is configured to:
determine that the acceleration operation satisfies the permission condition when a duration time in which an operation amount of the acceleration operation is equal to or more than a predetermined permission threshold operation amount is equal to or more than a predetermined threshold amount of time; and
cause the threshold amount of time to be smaller when the facilitation condition is met as compared to when the facilitation condition is not met.

3. The vehicle control apparatus according to claim 2, wherein the vehicle control apparatus is configured to determine that the prohibition condition is met when the operation amount is equal to or more than a predetermined prohibition threshold operation amount set to a value equal to or less than the permission threshold operation amount.

4. The vehicle control apparatus according to claim 1, wherein the vehicle control apparatus is configured to cause the permission condition to be met more easily when both of the state of the driver and the traveling state of the vehicle are an abnormal state as compared to when either the state of the driver or the traveling state of the vehicle is an abnormal state.

5. The vehicle control apparatus according to claim 1, wherein the vehicle control apparatus is configured to:
determine that the state of the driver is abnormal when the driver is dozing off, has fainted, or is having a convulsion; and
determine that the traveling state is abnormal when the vehicle travels out of a traveling lane, the vehicle travels in a wrong direction in the traveling lane, or the vehicle travels at a speed equal to or more than a speed limit.
